(19) United States
(12) Patent Application Publication
(10) Pub. No.: US 2006/0163499 A1
(43) Pub. Date: Jul. 27, 2006

(54) Apparatus and method for irradiating electron beam

(75) Inventors: Naoyuki Echigo, Tokyo (JP); Yo Marui, Tokyo (JP); Yoshihiro Fuse, Tokyo (JP); Mamoru Usami, Tokyo (JP); Kazushi Tanaka, Tokyo (JP); Minao Himeno, Tokyo (JP); Yukio Kaneko, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Toyo Ink Manufacturing Co., Ltd., Tokyo (JP); TDK Corporation, Tokyo (JP)

(21) Appl. No.: 11/338,392

(22) Filed: Jan. 24, 2006

(30) Foreign Application Priority Data
Jan. 26, 2005 (JP) 2005-018701

(51) Int. Cl. G21K 5/10; G01N 23/00

(52) U.S. Cl. 250/492.22; 250/491.1

(57) ABSTRACT

An electron beam irradiation apparatus includes an electron beam emission section having an electron beam irradiating tube that emits an electron beam; an electron beam irradiation section for irradiating the emitted electron beam to a target; a transfer mechanism for transferring the target to the electron beam irradiation section; a rotation mechanism for rotating the target on its own axis when irradiating the electron beam; and a linear movement mechanism for generating a relative linear movement such that the electron beam irradiating tube passes right above the target, between the target and the electron beam irradiating tube, when irradiating the electron beam. The linear movement mechanism generates a relative linear movement such that the electron beam irradiating tube goes from an end portion of the target toward the center of the target and turns back before the center of the electron beam emitting portion of the electron beam irradiating tube reaches the center of the target.

### BACKGROUND OF THE INVENTION

1. Field of the Invention

The present invention relates to electron beam irradiation techniques for irradiating an electron beam to a target (such as a display unit, an optical disk, glasses, an ID card, etc.) in order to cross-link or cure a coating (such as printing ink, paint, an adhesive, a pressure sensitive adhesive, a hard protective film, etc.) formed on the target, or in order to sterilize the target or modify its properties.

2. Description of the Related Art

Numerous electron beam irradiation techniques have hitherto been proposed for the cross-linking, curing, or property-modification of paint, an adhesive, a pressure sensitive adhesive, a hard protective film, etc., formed on a substrate. Such techniques are disclosed, for example, in Jpn. Pat. Appln. KOKAI Publication No. 2-208325. In the electron beam irradiation techniques, electrons are accelerated in a vacuum by an accelerating voltage, and the accelerated electrons are irradiated to a target placed in a vacuum or under an inert-gas atmosphere.

The electron irradiation techniques have many advantages: they hardly heat a target; they need not to use organic solvents; they require no curing initiator; and so fourth. On the other hand, because the techniques require a large drum type irradiating tube and accelerating voltage is high, they have the following technical problems: they require strict X-ray shielding; and in order to prevent oxygen inhibition (inhibition of curing by oxygen) it is necessary to flow a large amount of inert gas such as nitrogen gas so that the concentration of oxygen in the atmosphere around a target is reduced.

Because of such technical problems, widely used electron beam irradiation apparatuses are extremely large in size and heavy in weight.

In contrast to this, Jpn. Pat. Appln. KOKAI Publication No. 9-101400 discloses a technique that attempts to alleviate such trouble as much as possible by improving a system for transferring a target. This technique, however, does not meet the demand for downsizing, because an apparatus with a load-lock camber is further enclosed in a shielding chamber made of lead.

U.S. Pat. No. 5,414,267 discloses a technique for downsizing an electron beam irradiation section, and making an accelerating voltage lower. This technique realizes a high transmittance even at low accelerating voltages by improving the material of an electron beam irradiation window. This can reduce the amount of X-rays generated, downsize the electron beam irradiation section itself, and simplify an X-shielding structure in comparison with drum types. Thus, the electron beam irradiation apparatus can be downsized to some degree. In the case where this technique is employed to irradiate an electron beam to a target with a relatively large area, a large number of irradiating tubes are arranged for purposes of shortening the processing cycle while ensuring a sufficient dose. This arrangement, however, will increase the size of the electron beam irradiation apparatus itself and reduce the advantage of downsizing the electron beam irradiation section. In addition, a large amount of inert gas is consumed to cool down the electron beam irradiation window, so that the running cost is increased. Furthermore, an electron beam is not necessarily irradiated to a target with desired uniformity, so uniformity in irradiation doses is being requested.

### BRIEF SUMMARY OF THE INVENTION

The present invention has been made in view of the circumstances described above. Accordingly, it is an object of the present invention to provide an electron beam irradiation apparatus and an electron beam irradiation method which are small in size, small in the amount of inert gas consumed, and short in the cycle of processing a target by electron-beam irradiation. Another object of the present invention is to provide an electron beam irradiation apparatus and an electron beam irradiation method in which, adding above, uniformity in irradiation doses, or uniformity in absorbed doses, is high.

In accordance with a first aspect of the present invention, there is provided an electron beam irradiation apparatus which comprises: an electron beam emission section having an electron beam irradiating tube that emits an electron beam; an electron beam irradiation section for irradiating to a target the electron beam emitted from the electron beam emission section; a transfer mechanism for transferring the target to the electron beam irradiation section; a rotation mechanism for rotating the target on its own axis when irradiating the electron beam to the target; and a linear movement mechanism for generating a relative linear movement such that the electron beam irradiating tube passes above the target, between the target and the electron beam irradiating tube, when irradiating the electron beam to the target;

wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section by the transfer mechanism.

In accordance with a second aspect of the present invention, there is provided an electron beam irradiation apparatus which comprises: an electron beam emission section having an electron beam irradiating tube that emits an electron beam; an electron beam irradiation section for irradiating to a target the electron beam emitted from the electron beam emission section; a transfer mechanism for transferring the target to the electron beam irradiation section; a rotation mechanism for rotating the target on its own axis when irradiating the electron beam to the target; and a linear movement mechanism for generating a relative linear movement such that the electron beam irradiating tube passes right above the target, between the target and the electron beam irradiating tube, when irradiating the electron beam to the target;

wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section by the transfer mechanism;

and wherein, during the irradiation, the linear movement mechanism generates a relative linear movement such that the electron beam irradiating tube goes from an end portion of the target toward the center of the target and turns back before the center of an electron beam emitting portion of the electron beam irradiating tube reaches the center of the target.

In accordance with a third aspect of the present invention, there is provided an electron beam irradiation apparatus which comprises: a transfer container which is capable of X-ray shielding and airtight holding and in which a target is turned and transferred; a transfer mechanism for turning and transferring the target within the transfer container; an electron beam irradiation section, formed within the transfer container, for irradiating an electron beam to the target; a replacing chamber formed within the transfer container so that the target can be replaced; an electron beam emission section, having an electron beam irradiating tube that emits an electron beam, for emitting the electron beam to the target in the electron beam irradiation section; a replacement mechanism for replacing the target in the replacing chamber; a rotation mechanism for rotating the target on its own axis when irradiating the electron beam to the target; and a linear movement mechanism for generating a relative linear movement such that the electron beam irradiating tube passes right above the target, between the target and the electron beam irradiating tube, when irradiating the electron beam to the target;

wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section of the transfer container by the transfer mechanism.

In accordance with a fourth aspect of the present invention, there is provided an electron beam irradiation apparatus which comprises: a transfer container which is capable of X-ray shielding and airtight holding and in which a target is turned and transferred; a transfer mechanism for turning and transferring the target within the transfer container; an electron beam irradiation section, formed within the transfer container, for irradiating an electron beam to the target; a replacing chamber formed within the transfer container so that the target can be replaced; an electron beam emission section, having an electron beam irradiating tube that emits an electron beam, for emitting the electron beam to the target in the electron beam irradiation section; a replacement mechanism for replacing the target in the replacing chamber; a rotation mechanism for rotating the target on its own axis when irradiating the electron beam to the target; and a linear movement mechanism for generating a relative linear movement such that the electron beam irradiating tube passes right above the target, between the target and the electron beam irradiating tube, when irradiating the electron beam to the target;

wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section of the transfer container by the transfer mechanism;

and wherein, during the irradiation, the linear movement mechanism generates a relative linear movement such that the electron beam irradiating tube goes from an end portion of the target toward the center of the target and turns back before the center of an electron beam emitting portion of the electron beam irradiating tube reaches the center of the target.

In accordance with a fifth aspect of the present invention, there is provided an electron beam irradiation method of irradiating to a target an electron beam emitted from an electron beam irradiating tube, which comprises a step of irradiating the electron beam from the electron beam irradiating tube to the target, while rotating the target on its own axis and also generating a relative linear movement such that the electron beam irradiating tube passes right above the target, between the target and the electron beam irradiating tube.

In accordance with a sixth aspect of the present invention, there is provided an electron beam irradiation method of irradiating to a target an electron beam emitted from an electron beam irradiating tube, which comprises a step of irradiating the electron beam from the electron beam irradiating tube to the target, while rotating the target on its own axis and also generating a relative linear movement such that the electron beam irradiating tube passes right above the target, between the target and the electron beam irradiating tube; and a step of, during the irradiation, generating a relative linear movement such that the electron beam irradiating tube goes from an end portion of the target toward the center of the target and turns back before the center of an electron beam emitting portion of the electron beam irradiating tube reaches the center of the target.

According to the aforementioned first, third, and fifth aspects of the present invention, while a target is being rotated on its own axis by the rotation mechanism and also a relative linear movement is being generated between the target and the electron beam irradiating tube by the linear movement mechanism, an electron beam is irradiated from the electron beam irradiating tube to the target. Therefore, one electron beam irradiating tube suffices for uniform irradiation and is able to reduce the size of the apparatus and the amount of an inert gas used to prevent oxygen inhibition to a target. By generating a relative linear movement between the target and the electron beam irradiating tube while rotating the target on its own axis, even one electron beam irradiating tube can irradiate the whole surface of the target in a short time. In addition, as the apparatus itself is small in size, the time to introduce an inert gas into the apparatus is short and therefore the cycle of processing the target by electron-beam irradiation can be shortened.

According to the aforementioned second, fourth, and sixth aspects of the present invention, between the target and the electron beam irradiating tube there is generated a relative liner movement such that the electron beam irradiating tube goes from an end portion of the target toward the center of the target and turns back before the center of the electron beam emitting portion of the electron beam irradiating tube reaches the center of the target. This is able to appropriately reduce the absorbed dose of the central portion of the target where an absorbed dose by electron-beam irradiation is liable to increase. Therefore, uniformity in irradiation doses, or uniformity in absorbed doses, can be enhanced.

In the aforementioned first, third, and fifth aspects of the present invention, the linear movement mechanism may be constructed so that it generates the relative linear movement so that the center of the electron beam emitting portion of the electron beam irradiating tube does not pass the center of the target. This can reduce the irradiation dose of the central portion of the target where an irradiation dose is apt to increase, when during the relative movement the electron beam irradiating tube reaches the target center or passes through the target. Thus, uniformity in irradiation doses can be enhanced.

In the aforementioned second, fourth, and sixth aspects of the present invention, when irradiation doses from the electron beam irradiating tube are normally distributed so that the center thereof is strongest, d/W_{H} (where W_{H} is the half-value width and d is the distance of the turning-back position from the center of the target) may be a position that is in a range of 0.25 to 0.79. In that case, uniformity in irradiation doses can be enhanced. In addition, the turning-back position during the relative linear movement of the linear movement mechanism may be a position 5.8 to 18.2 mm away from the center of the target. This can enhance uniformity in irradiation doses. Furthermore, when the relative linear movement has no stop time at the turning-back position, the turning-back position during the relative linear movement may be a position W_{H}/2 away from the center of the target. This can enhance uniformity in irradiation doses.

As in the aforementioned third and fourth aspects, when the electron beam irradiation apparatus has a transfer container which is capable of X-ray shielding and airtight holding and in which a target is turned and transferred, a transfer mechanism for turning and transferring the target within the transfer container, an electron beam irradiation section, formed within the transfer container, for irradiating an electron beam to the target, and a replacing chamber formed within the transfer container so that the target can be replaced, the apparatus suffices if the entire transfer system has a space for turning the target 1. This can further reduce the size of the entire apparatus.

In this case, the apparatus may be constituted such that the replacement mechanism has a target holding tray for holding the target and an external transfer mechanism for transferring the target holding tray between a first position in the transfer container at which the replacing chamber is formed and a second position outside the transfer container, and that the target holding tray may become part of the replacing chamber while holding a target held at the second position outside the transfer container, and causes the replacing chamber to be in an X-ray shielding and airtight state in cooperation with the support tray positioned in there placing chamber, and in the X-ray shielding and airtight state, the target being held by the target holding tray may be transferred to the support tray positioned in the replacing chamber. In this construction, the target holding member and support member function as a load lock door and also the support member functions as a transfer member for a target. Therefore, the entire apparatus becomes extremely compact. This is able to further reduce the amount of inert gas to be introduced into the transfer chamber, shorten the time to fill the transfer chamber with an inert gas, and shorten the cycle of processing a target by electron-beam irradiation.

The electron beam irradiation apparatus may be constituted such that the apparatus is further include a depressurization mechanism for depressurizing the replacing chamber airtightly held, and a gas mechanism for filling the replacing chamber with an inert gas by introducing the inert gas into the replacing chamber after or during decompression, and that in replacing the target, the replacing chamber may be opened to the atmosphere, and after the target is transferred into the replacing chamber, the replacing chamber may be caused to be in an inert-gas atmosphere. This makes it possible to effectively utilize the load-lock function of the replacing chamber.

The electron beam irradiation apparatus may be constituted such that, the transfer mechanism includes a plurality of support trays each having a target support member that supports a target, that, when one of the support trays is positioned in the electron beam irradiation section, at least one support tray of the other support trays is positioned in the replacing chamber, and that in the state, while an electron beam is being irradiated to one target in the electron beam irradiation section, another target is replaced in the replacing chamber. This makes it possible to perform replacements of targets and electron-beam irradiation at the same time and therefore the processing cycle can be further shortened.

The electron beam irradiation apparatus may be constituted such that the apparatus further includes a vertical-movement mechanism for vertically moving the transfer mechanism, and that, when a target is supported within the support tray by the target support member and the support tray is positioned in the replacing chamber, the transfer mechanism is raised by the vertical-movement mechanism so that the replacing chamber is caused to be in an X-ray shielding and airtight state. This makes it possible to form the replacing chamber extremely easily.

The electron beam irradiation apparatus may be constituted such that, the rotation mechanism has a power transmission member for transmitting a rotating force to the target support member, a rotating shaft attached to the power transmission member, and a rotating unit for rotating the rotating shaft, that, the linear movement mechanism has a linear drive unit for transmitting a linearly driving force to the target support member by horizontally moving the power transmission member and the rotating shaft, and that the power transmission member is provided so that it is able to contact to or separate from the target support member.

In all of the aforementioned aspects, the electron beam irradiating tube is made a vacuum type, whereby a reduction in the transmittance of an electron beam is slight even at a low accelerating voltage of 80 kV or less, an electron beam can be taken out effectively, and the electron beam irradiation apparatus can be further downsized. The low accelerating voltage also makes it possible to cause an electron beam to act on a target effectively at a low depth, to reduce an adverse influence on a substrate and the amount of secondary X-rays generated, and to use stainless steel in place of harmful lead as a material for X-ray shielding.

### BRIEF DESCRIPTION OF THE DRAWINGS

The present invention will be described in further detail with reference to the accompanying drawings wherein:

FIG. 1 is a vertical sectional view showing an electron beam irradiation apparatus constructed in accordance with a first embodiment of the present invention;

FIG. 2 is a horizontal sectional view showing the electron beam irradiation apparatus constructed in accordance with the first embodiment;

FIG. 3 is a plan view showing a shutter mechanism that is employed in the electron beam irradiation apparatus constructed in accordance with the first embodiment;

FIGS. 4A, 4B, and 4C are plan views for explaining a relative linear movement between a target and an electron beam irradiating tube that is generated in accordance with the first embodiment;

FIG. 5 is a perspective view showing the electron beam irradiating tube that is employed in the electron beam irradiation apparatus constructed in accordance with the first embodiment;

FIGS. 6 to 8 are vertical sectional views used to explain operation of the electron beam irradiation apparatus constructed in accordance with the first embodiment;

FIG. 9 is a diagram showing distribution of electron beam doses irradiated from an electron beam irradiating tube;

FIG. 10 is a diagram showing distribution of absorbed doses in the radial direction of a disk target in the case where there is no stop time at a turning-back position, by varying d/W_{H};

FIG. 11 is a diagram showing distribution of absorbed doses in the radial direction of a disk target in the case where the stop time at a turning-back position is 5% of the total irradiating time, by varying d/W_{H};

FIG. 12 is a diagram showing doses absorbed at a target center when the turning-back position is varied, in terms of an increase and decrease from an average value, for the case where the stop time is 0 and the case where the stop time is about 5% of the total irradiating time;

FIGS. 13A and 13B are diagrams used to explain a relationship between the direction of inert-gas supply and the direction of rotation of a target when a relative linear movement having no turning-back position near the center of the target is performed between the target and the electron beam irradiating tube; and

FIG. 14 is a diagram used to explain how a relative linear movement between a target and an electron beam irradiating is generated in accordance with a second embodiment of the present invention.

### DETAILED DESCRIPTION OF THE INVENTION

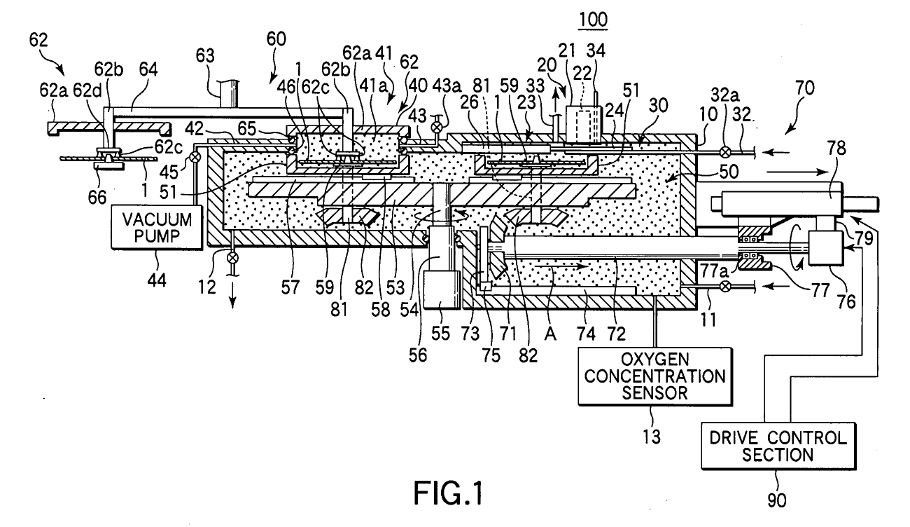

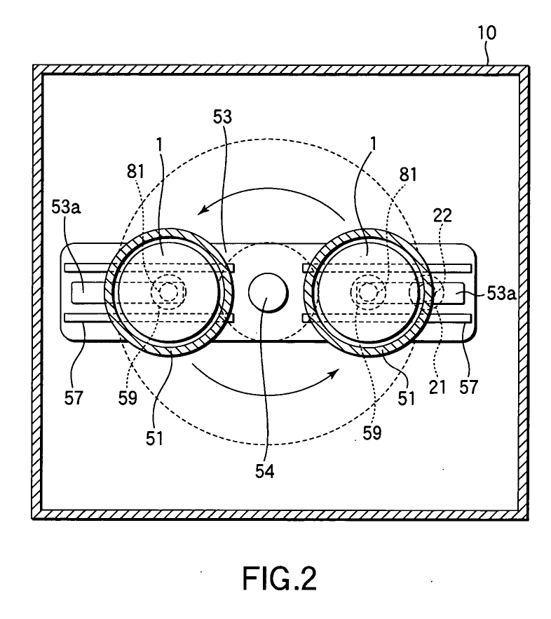

Referring now to FIGS. 1 and 2, there is shown an electron beam irradiation apparatus 100 constructed in accordance with a first embodiment of the present invention. The electron beam irradiation apparatus 100 has a chamber 10 that is a transfer container that is capable of X-ray shielding and airtight holding, and an electron beam emission section 20 mounted in the ceiling wall portion of the chamber 10. The chamber 10 contains an electron beam irradiation section 30 for irradiating an electron beam to a target 1, and a replacing chamber 40 for replacing the target 1. The electron beam irradiation apparatus 100 further has a transfer mechanism 50 for turning and transferring a target within the chamber 10; a replacement mechanism 60 for replacing a target in the replacing chamber 40; and a rotation and linear-movement section 70 for rotating and linearly moving a target in the electron beam irradiation section 30.

The transfer mechanism 50 has two support trays 51 for supporting the target 1 and a turning arm 53 for supporting the respective support trays 51 so that they are linearly slidable and also turning (or revolving) these support trays 51. The turning arm 53 is turnable on a turning shaft 54 disposed at the center of the chamber 10. It should be noted that the term “turn” used in this specification, differing from rotation in which the target is continuously rotation in one direction (or the opposite direction), it is turned while shifting stop rotations, such that it is turned by a predetermined amount in one direction or the opposite direction, and is then stopped there.

The turning arm 53 extends straight in opposite directions from the turning shaft 54 so that the two support trays 51 are arranged at an angle of 180 degrees to each other. The turning shaft 54 is rotated by a rotating motor 55 disposed under the chamber 10, whereby the turning arm 53 is turned within the chamber 10. The turning shaft 54 is also movable vertically by a cylinder 56, whereby the turning arm 53 and support trays 51 are moved up and down.

The turning arm 53 forms a plate shape and two pairs of linear guide rails 57 are mounted thereon, the two guide rail pairs respectively corresponding to the two support trays 51. Each guide rail pair is provided with a slider 58 on which the support tray 51 is mounted. Thus, the support tray 51 is slidable along the guide rails 57 through the slider 58. The support tray 51 forms a cylindrical shape which is closed at its lower end, the central portion being provided with a rotatable target support member 59 for detachably supporting the target 1. As described later, a rotating shaft 81 for rotating the target support member 59 within the support tray 51 extends downward and is movable horizontally along an elongated bore 53a that is formed in the turning arm 53.

The target 1 is, for example, a flat object that has a surface coated with a resin layer, such as printing ink, paint, an adhesive, a protective film, etc., by spinning-coating, applying, spraying, or other methods.

An inert gas introduction tube 11, a gas exhaust tube 12, and an oxygen concentration sensor 13 are connected to the walls of the chamber 10. A gas control section (not shown) controls the flow rate of an inert gas such as nitrogen gas so that the concentration of oxygen within the chamber 10 measured by the oxygen concentration sensor 13 becomes a predetermined value or less.

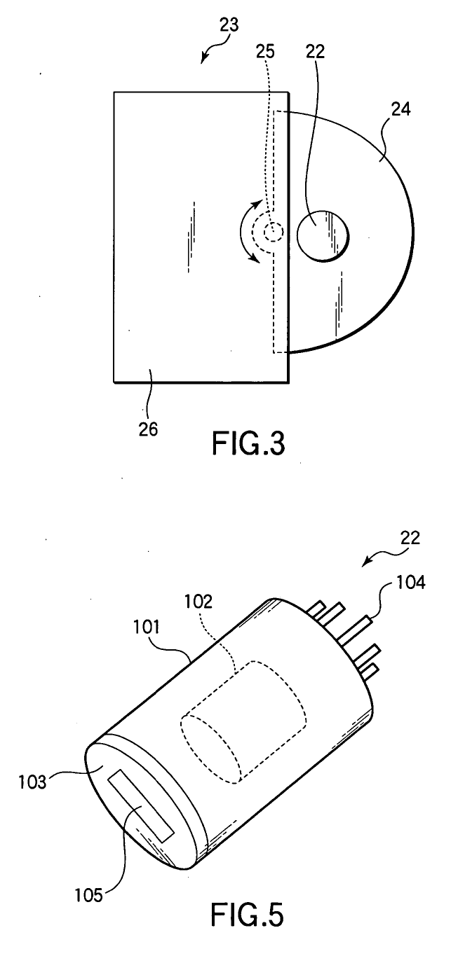

The electron beam emission section 20 is airtightly connected to the chamber 10 and is equipped with a shielding box 21 for preventing the escape of X-rays, one electron beam irradiating tube 22 housed within the shielding box 21, and a shutter mechanism 23 for controlling whether an electron beam is irradiated or not from the electron beam irradiating tube 22 to the target 1. The shutter mechanism 23, as shown in detail in FIG. 3, is equipped with a shutter 24, a pivot shaft 25 for pivotally supporting the shutter 24, and a pivot mechanism 26 for pivoting the shutter 24 on the pivot shaft 25 to open or close the shutter 24. The electron beam irradiating tube 22 is disposed in the opening of the lower end of the shielding box 21, with its electron beam emitting portion downward. Note that in starting irradiation, if the target 1 can be moved to a position at which no electron beam is irradiated, the shutter 24 is not necessarily required. In addition, although the electron beam irradiating tube 22 is continuously emitting an electron beam during an irradiation process, the electron beam may be turned on and off.

The shielding-box installing portion in the electron beam irradiation section 30 of the chamber 10 is provided with an inert gas introduction tube 32 and an inert gas exhaust tube 33 so that an inert gas such as nitrogen gas for cooling is circulated near the lower end of the electron beam irradiating tube 22. The inert gas introduction tube 32 is provided with an inert gas introduction control valve 32a for controlling the flow rate of an inert gas to be supplied for cooling. A gas control section (not shown) controls the supply or flow rate of an inert gas, based on a temperature near the lower end of the electron beam irradiating tube 22 detected by a temperature sensor 34. In this manner, it is possible to effectively cool down the electron beam irradiating tube 22 with the minimum amount of inert gas. If the concentration of oxygen within the chamber 10 is sufficiently reduced by an inert gas such as nitrogen gas thus supplied for cooling, the introduction of an inert gas from the inert gas introduction tube 11 is unnecessary.

The electron beam irradiation section 30 is located underneath the electron beam emission section 20. The support tray 51 is first positioned in the electron beam irradiation section 30 by turning the turning arm 53 with the transfer mechanism 50, and with the turning arm 53 raised by the cylinder 56, an electron beam is irradiated to the target 1.

The portion opposite to the electron beam irradiation section 30 of the chamber 10 is provided with a replacing chamber section 41 in which the replacing chamber 40 is formed. An opening 41a is formed in the upper portion of the replacing chamber section 41. At the position corresponding to the support tray 51, a shielding seal 46 is installed in the inside portion of the chamber ceiling wall so as to surround the opening 41a. When the support tray 51 is positioned underneath the opening 41a by turning the turning shaft 54 with the rotating motor 55 and is raised by the cylinder 56, the support tray 51 is pressed against the shielding seal 46 so that the inside of the support tray 51 is airtightly sealed.

A replacement mechanism 60 for replacing a target is disposed outside the chamber 10 and near the replacing chamber 41. This replacement mechanism 60 comprises an external transfer arm 64 which has a span linking between the replacing chamber section 41 and a target delivering section 66, and is movable up and down, and two target holding trays 62 attached to the opposite ends of the external transfer arm 64.

Each of the target holding trays 62 has a planular and cylindrical main body 62a that is closed at its upper end; a holding arm 62b, attached to one of the opposite ends of the external transfer arm 64 and penetrating the central portion of the main body 62a, for supporting the main body 62a; and a holder 62c, attached to the bottom surface of the holding arm 62b, for detachably holding the target 1. The holder 62c has an appropriate suction mechanism such as a vacuum suction mechanism. To prevent a fall of the main body 62a, the lower end of the holding arm 62b has a flange portion 62d on which the holder 62c is provided. Although not shown, the portion of the main body 62c that the holding arm 62b pentrates of the target holding tray 62 is provided with a shielding seal structure so that airtight holding and X-ray shielding are obtained between the penetrating portion of the holding arm 62b and the center portion of the main body 62a.

A turning shaft 63 is fixed on the center portion of the external transfer arm 64 and is driven by a drive mechanism (not shown) so that the external transfer arm 64 is turned and is vertically moved. By holding a target from the target delivering section 66 by one of the two target holding trays 62, then holding a target from the support tray 51 of the replacing chamber section 41 by the other target delivering member 62, and then turning and vertically moving the external transfer arm 64, the two targets can be replaced with each other between the target delivering section 66 and the support tray 51 that is positioned in the replacing chamber section 41.

A shielding seal 65 is installed in the outside portion of the chamber ceiling wall so as to surround the opening 41a formed in the chamber ceiling wall. When the external transfer arm 64 is lowered and the target holding tray 62 is brought into direct contact with the shielding seal 65, airtight holding and X-ray shielding can be obtained. More specifically, by positioning the support tray 51 in the replacing chamber section 41 of the chamber 10, then bringing that support tray 51 into direct contact with the shielding seal 46 at the position corresponding to the opening 41a, and then moving the target holding tray 62 so as to close the opening 41a, the replacing chamber 40 is formed. In forming the replacing chamber 40, the target holding tray 62 forms the upper portion of the replacing chamber 40. Thus, when the replacing chamber 40 is caused to function as a load-lock chamber, the target 1 can be moved in and out of the chamber 10, without reducing the inert gas of the chamber 10 and while preventing leakage of X-rays.

A vacuum exhaust path 42 and a replacing-gas supply path 43 are connected to the replacing chamber 40 through the ceiling wall of the chamber 10. The replacing chamber 40 is evacuated through the vacuum exhaust path 42 and is supplied with an inert gas such as nitrogen gas as a replacing gas through the replacing-gas supply path 43. The replacing-gas supply path 43 is provided with a replacing-gas supply control valve 43a.

The vacuum exhaust path 42 is provided with an exhaust control valve 45 and is connected to a vacuum pump 44 through the exhaust control valve 45. The replacing-gas supply path 43 is connected to an inert-gas supply source and is provided with the replacing-gas supply control valve 43a to control the supply of an inert gas to the replacing chamber 40.

The aforementioned chamber 10, support tray 51, and target holding tray 62 are made of metal having the necessary thickness for preventing the escape of X-rays generated during electron beam irradiation. The inner shielding seal 46 between the chamber 10 and the support tray 51, and the outer shielding seal 65 between the chamber 10 and the target holding tray 62, each have a step portion (not shown) so that even if there is a slight gap between them, X-rays do not leak out of the gap (only reflected X-rays leak out). The aforementioned metal with the necessary thickness for X-ray shielding and the step portions of the shielding seals 46, 65 constitute an X-ray shielding mechanism. More specifically, generally, if a shielding seal has a configuration such that X-rays from an X-ray source leak out after two or more reflections, the amount of X-rays that leak out is safe because the X-ray amount is extremely reduced to a safe X-ray level existing in normal environment.

The rotation and linear-movement section 70 is disposed under the electron beam irradiation section 30 and comprises a power transmission member 71 for transmitting power to the support tray 51; a rotating shaft 72 inserted into the center of the power transmission member 71 and horizontally extending out of the chamber 10; a rotating-shaft support member 73 for supporting the rotating shaft 72 at the central portion of the chamber 10; a linear guide rail 74, provided on the bottom portion of the chamber 10, for guiding the rotating-shaft support member 73; a slider 75, movable along the linear guide rail 74, for supporting the rotating-shaft support member 73; a rotating motor 76 as a rotation mechanism for rotating the rotating shaft 72; an engagement member 77 fitted on the rotating shaft 72 through a bearing 77a; and a linear motor 78 as a linear movement mechanism, attached to the chamber 10, for linearly moving the rotating shaft 72 and power transmission member 71 along the direction indicated by an arrow A. The rotating motor 76 is coupled with the linear motor 78 through a coupling member 79.

The target support member 59 for supporting a target within the support tray 51 is attached at its bottom surface on a rotating shaft 81 extending downward vertically, the lower end portion of which is fixed to a power transmission member 82. If the horizontal power transmission member 71 of the rotation and linear-movement section 70 is caused to engage with the vertical power transmission member 82, rotation of the rotating motor 76 and linear movement of the linear motor 78 are transmitted and therefore the target 1 supported by the target support member 59 can be rotated and also it can be moved in a straight line in the direction A. The power transmission members 71, 82 may employ well-known various power transmission types such as a gear mechanism, a type in which metal surfaces contact each other, a non-contact type employing magnetic force, etc.

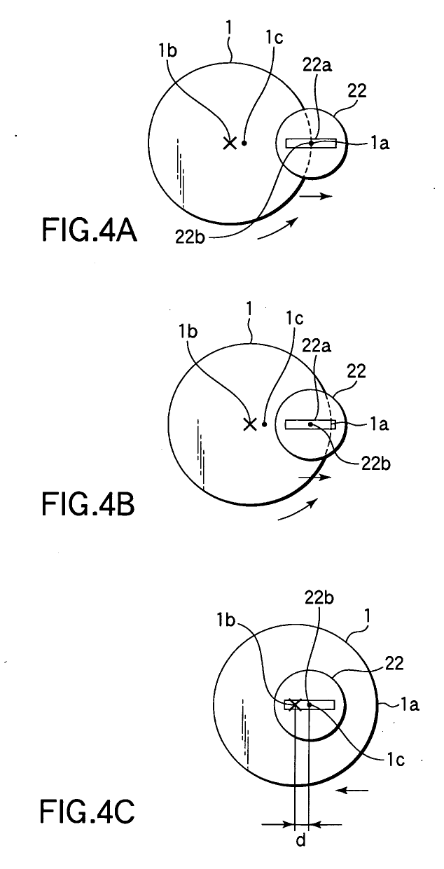

The driving of the rotating motor 76 and linear motor 78 is controlled by a drive control section 90. More specifically, the drive control section 90 controls the rotating motor 76 so that the target 1 within the support tray 51 at the position shown in FIG. 1 of the electron beam irradiation section 30 is rotated, and as shown in FIGS. 4A to 4C, controls the driving of the linear motor 78 so that there is generated a movement such that (1) the electron beam irradiating tube 22 passes above the target 1 and (2) the electron beam irradiating tube 22 moves from an end la of the target 1 toward its center 1b and, when the center 22b of the electron beam emitting portion 22a reaches a position 1c short of the center 1b of the target 1, turns back.

A preferred example of the electron beam irradiating tube 22 in the electron beam irradiation section 20 is a vacuum tube type of electron beam irradiating tube disclosed in the aforementioned U.S. Pat. No. 5,414,267. This type of electron beam irradiating tube 22 is constructed as shown in FIG. 5. That is, it has a cylindrical vacuum tube 101 made of glass or ceramic; an electron beam source 102, disposed within the vacuum tube 101, for taking out electrons emitted from its cathode as an electron beam and accelerating the electron beam; an electron beam emitting portion 103, attached to one end of the vacuum tube 101, for emitting the electron beam; and an electricity supply pin portion 104 to which power is supplied from a power supply (not shown). The electron beam emitting portion 103 is provided with an irradiation window 105 in the form of a thin film that functions as the aforementioned electron beam emitting portion 22a. The irradiation window 105 of the electron beam emitting portion 103 prevents gas from passing through but allows an electron beam to pass through, and forms a slit shape.

The vacuum tube type of electron beam irradiating tube 22 is entirely different from the conventional drum type electron beam irradiation source, which is of a type in which an electron beam is irradiated while constantly producing a vacuum within the drum. The conventional drum type electron beam irradiation source is large in size and, as set forth above, is fairly difficult to employ in a transfer line. It is also difficult to adjust electron current, accelerating voltage, distance, etc., in the aforementioned manner. On the other hand, the electron beam source with the irradiating tube constituting described above is small in size and can be easily arranged in a transfer line. In addition, since the electron beam source with the irradiating tube is able to take out an electron beam effectively at a low accelerating voltage of 80 kV or less and is good in controllability, the aforementioned adjustments can be readily made. An adverse influence on a substrate that underlies a layer to which an electron beam is irradiated is also slight. Such a low accelerating voltage also reduces the amount of radiation (such as X-ray), so a radiation shielding device can be reduced in size and cost.

Normally, electron-beam irradiation is performed by replacing with an atmosphere of an inert gas such as nitrogen gas, but in the case of vacuum tube type electron beam sources, the degree of atmosphere replacement does not need to be high and, depending upon conditions, it is also possible to perform electron-beam irradiation under an inert-gas containing atmosphere close to air.

Now, operation of the aforementioned electron beam irradiation apparatus 100 will be described.

As mentioned later, in the first embodiment, replacement of the target 1 and irradiation of an electron beam are continuously repeated. However, for the sake of convenience, they will be described from the state of FIG. 1.

In FIG. 1, the interior of the chamber 11 is filled with an inert gas that is introduced through the inert gas introduction tube 11 and flows out through the gas exhaust tube 12, and the concentration of oxygen detected by the oxygen concentration sensor 13 is controlled so that it becomes a predetermined value or less.

In the replacing chamber section 41, the external transfer arm 64 is lowered, whereby the circumferential portion of the target holding tray 62 is brought into airtight contact with the circumferential portion of the opening 41a of the ceiling wall of the chamber 10 through the outer shielding seal 65. Then, with the turning arm 53 raised, the circumferential portion of one of the two supporting trays 51 is airtightly held in contact with the circumferential portion of the opening 41a of the ceiling wall of the chamber 10 through the inner shielding seal 46. In this state, the replacing chamber 40 is airtightly sealed. On the other hand, the other of the two supporting trays 51 is positioned in the electron beam irradiation section 30.

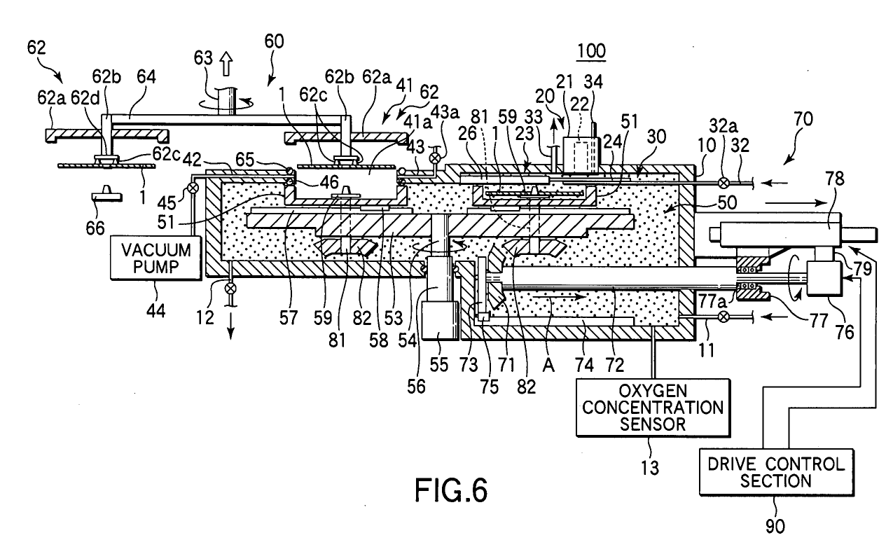

In this state, the irradiated target within the support tray 51 is suctioned and held by one of the holder 62c of the two target holding trays 62 of the replacement mechanism 60. At the same time, outside the chamber 10, an unirradiated target 1 on the target delivering section 66 is suctioned and held by the other holder 62c. Thereafter, as shown in FIG. 6, the outer transfer arm 64 is raised and the turning shaft 63 of the external transfer arm 64 is turned by 180 degrees, whereby the irradiated target 1 and the unirradiated target 1 are replaced with each other.

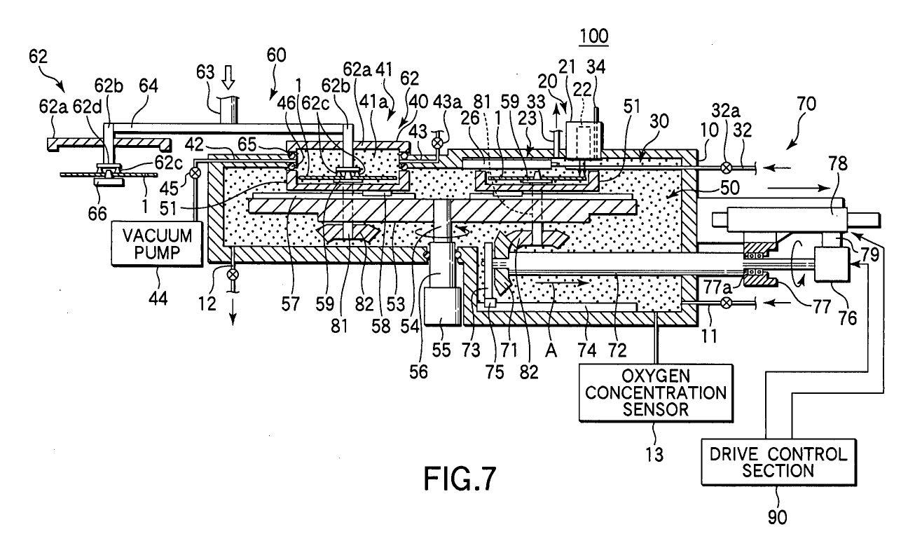

Thereafter, as shown in FIG. 7, the external transfer arm 64 is lowered. In this state, the unirradiated target 1 is delivered to the support tray 51, while the irradiated target 1 is delivered to the target delivering section 66. At this time, as with FIG. 1, an airtightly-sealed replacing chamber 40 is formed. With the replacing-gas supply control valve 43a closed, a vacuum is produced within the replacing chamber 40 by the vacuum pump 44. Thereafter, with the exhaust control valve 45 closed, the replacing-gas supply control valve 43a is opened and therefore an inert gas such as nitrogen gas is introduced in a short time into the replacing chamber 40 being in its vacuum state. This makes it possible to completely replace the interior of the replacing chamber 40 with a relatively small amount of inert gas in a short time.

At the same time when the operation of replacing targets is performed, as shown in FIG. 7, in the electron beam irradiation section 30 an electron beam is irradiated to a target 1 positioned within the support tray 51. More specifically, as shown in FIG. 7, the shutter 24 of the shutter mechanism 23 shown in FIG. 3 is retracted into the pivot mechanism 26. While the target 1 is being rotated and is being moved in the direction A by the rotation and linear-movement section 70, an electron beam is irradiated from the electron beam irradiating tube 22 to the target 1. During this irradiation, an inert gas such as nitrogen gas is introduced from the inert-gas introduction tube 32 into the chamber 10 to cool down the electron beam irradiating tube 22.

When an electron beam is being irradiated, the rotation and linear-movement section 70 is controlled by the drive control section 90 to rotate and linearly move the target 1 so that when viewed from the side of the target 1, there is generated a movement (shown in FIGS. 4A-4C ) such that (1) the electron beam irradiating tube 22 passes right above the target 1 and (2) the electron beam irradiating tube 22 moves from an end la of the target 1 toward its center 1b and, when the center 22b of the electron beam emitting portion 22a reaches the position 1c short of the center 1b of the target 1, turns back.

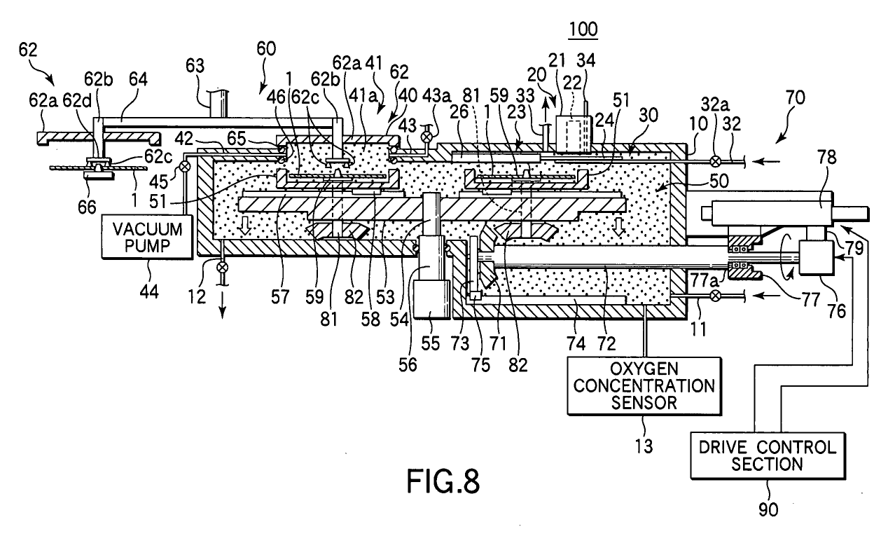

Thereafter, as shown in FIG. 8, the turning arm 53 is lowered by the cylinder 56 to disengage the support tray 51 in the replacing chamber 40 from the inner shielding seal 46, and then the turning arm 53 is turned so that the support tray 51 with an unirradiated target 1 is held at a predetermined position in the electron beam irradiation section 30. At the same time, the support tray 51 with the irradiated target 1 is transferred to the replacing chamber section 41 and positioned.

The turning arm 53 is raised by the cylinder 56 from the state of FIG. 8 to the state of FIG. 1 in which the support tray 1 in the replacing chamber section 41 is brought into direct contact with the inner shielding seal 46. In the aforementioned manner, the replacing chamber 40 is formed and the irradiated target 1 in the replacing chamber 40 is replaced with an unirradiated target 1 supported by the delivering section 66. At the same time, an electron beam is irradiated to the target 1 in the electron beam irradiation section 30. By repeating the aforementioned continuous operations, an electron beam can be continuously and efficiently irradiated to a plurality of targets 1.

Now, the irradiation of an electron beam to a target will be described in further detail.

As set forth above, in the first embodiment, irradiation doses are made uniform by rotating the target 1 so that when viewed from the side of the target 1, there is generated a movement (shown in FIGS. 4A to 4C) such that (1) the electron beam irradiating tube 22 passes right above the target 1 and (2) the electron beam irradiating tube 22 moves from the end 1a of the target 1 toward its center 1b and, when the center 22b of the electron beam emitting portion 22a reaches the position 1c short of the center 1b of the target 1, turns back.

More specifically, in the case where a relative linear movement between the electron beam irradiating tube 22 and the target 1 is generated with the target 1 being rotated at the same speed, the amount of an electron beam irradiated will be larger at the central portion of the target 1 where the circumferential speed is slow than at an end portion of the target 1 where the circumferential speed is fast, if the electron beam irradiating tube 22 turns back after the center 22b of the electron-bean emitting portion 22a of the electron beam irradiating tube 22 reaches or passes the center 1b of the target 1 or if the electron beam irradiating tube 22 moves to another end past the center 1b. Because of this, the absorbed doses will not become uniform. To avoid this, the speed of the relative linear movement or rotation speed of the target 1 can be varied, but it is fairly difficult to make electron beam doses uniform with the speed variations alone. That is, if uniformity in absorbed doses is to be obtained by the aforementioned relative linear movement and target rotation, the speed of the relative linear movement must be increased at the center of the target and an extremely high speed is required at the center of the target. From the viewpoint of transfer control, the maximum speed and maximum acceleration of the relative linear movement and the number of rotations of a target are important design parameters and therefore enhancing performance in order to realize such an extremely high speed will cause an increase in size and cost of the apparatus.

Hence, in the first embodiment, as set forth above, a relative linear movement between the electron beam irradiating tube 22 and the target 1 is generated so that the electron beam irradiating tube 22 turns back before the center 22b of the electron beam emitting portion 22a of the electron beam irradiating tube 22 reaches the center 1b of the target 1. This reduces the absorbed dose near the center 1b of the target 1 which becomes largest, whereby uniformity in absorbed doses can be achieved.

Now, uniformity in absorbed doses when varying a position at which the electron beam irradiating tube 22 turns back will be described.

If the absorbed dose of a target when irradiated with an electron beam is insufficient, uneven curing will tend to occur. On the other hand, if the absorbed dose is too large, substrate damage will be great or changes in the properties of a target will be caused by generation of heat. Therefore, uniformity in absorbed doses to such a degree that these problems are presented is needed all over the surface of a target. It is preferable that an absorbed dose at the target center be in a range of −30% to +50% of an average absorbed dose.

The preferred range will be described based on the following experimental results (1) and (2).

(1) A urethane family electron-ray curing type hard coating material was coated to a thickness of about 2 μm on an acrylic plate by a spin coater, and with the absorbed dose of the center as 70 kGy, the hard coating was cured with relative absorbed doses listed in Table 1. Thereafter, #0000 steel wool was caused to go and return 20 times with a weight of 250 g, and the resistance to scratch was evaluated by the number of scratches. The results are listed in Table 1. From the results it has been found that when an absorbed dose is less than −30%, the resistance to becomes a problem.

(2) The same hard coating material as that employed in (1) was coated on a thiourethane family plastic lens (MP-8 and a refractive index of 1.60) with the same conditions and was cured. Thereafter, the degree of yellowing (YI value) of the lens was measured by an integrating spherical spectrophotometer “CMS-35SP” (Murakami Color Technology Institute). The results are listed in Table 1. The practical range of YI values is 3.0 or less. It has been found that when an absorbed dose is greater than +50%, the YI value exceeds 3 and damage to the substrate becomes a problem.

From the foregoing results, it has been confirmed that it is preferable that an absorbed dose at the center of a target be in a range of −30% to +50% of an average absorbed dose.

TABLE 1

| Absorbed dose | Unirradiated | −40% | −30% | 0% | +50% | +60% |
|---|---|---|---|---|---|---|
| Resistance to | Large number | 11 | 1 | 0 | 0 | 0 |
| Scratch | | | | | | |
| (number of | | | | | | |
| scratches) | | | | | | |
| Resistance to | 2.12 | 2.5 | 2.62 | 2.75 | 2.94 | 3.05 |
| yellowing | | | | | | |
| (YI value) | | | | | | |

On the other hand, in the case where an electron beam is irradiated to a target being rotated on its own axis, irradiating time needs to be made shorter as the circumferential speed becomes slower, and therefore a relative speed between an irradiating tube and a target needs to be made greater as the circumferential speed becomes slower. Therefore, it is necessary that the relative speed be great at a turning-back position. However, by the demand for a further reduction in size and cost of the transfer mechanism, acceleration needs to be slowed down to some degree. Therefore, at a turning-back position, slight stop time or low-speed transferring time must be taken into consideration. In such a case, an irradiation dose will increase at a turning-back position.

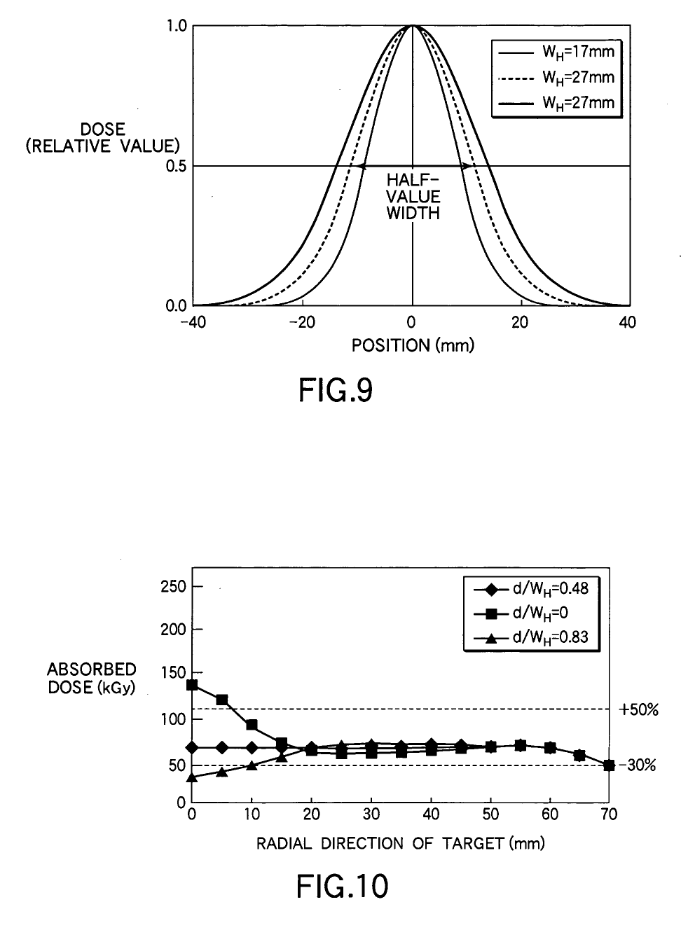

Hence, in the case that there is stop time at a turning-back position, and in the case that there is no stop time, simulation of absorbed dose was carried out by varying the turning-back position and uniformity in absorbed dose was confirmed. In this simulation, a target in the form of a disk was employed. The number of revolutions was 600 rpm, and the speed of the relative linear movement was 0 mm/s at the outer circumferential portion of the target, and the maximum speed in moving from the outer circumference toward the center was 192 mm/s, so as to optimize the conditions in each case. In generally, the irradiation dose of an electron beam emitted from an electron beam irradiating tube is normally distributed as shown in FIG. 9. Therefore, in this simulation, irradiation doses from the electron beam irradiating tube were assumed to be normal distribution. In addition, since the influence of the turning-back position is influenced by the half-value width (W_{H}) of the electron beam irradiating tube shown in FIG. 9, d/W_{H} (where d is the distance of the turning-back position from the center) was employed. Note that the half-value widths (W_{H}) shown in FIG. 9 are 17 mm, 22 mm, and 27 mm, respectively.

FIG. 10 shows distribution of absorbed doses in the radial direction of a disk target in the case where there is no stop time at a turning-back position (center absorbed dose 70 kGy) . In this case, d/W_{H} is caused to vary to 0, 0.48, and 0.83. From this figure it is found that when d/W_{H} is 0.48, that is, when the distance d of the turning-back position from the center is about ½ of the half-value width d/W_{H}, uniformity in absorbed doses is best. When d/W_{H} is 0, that is, when a target turns back at a position where its center coincides with an irradiating tube center, the absorbed dose at the target center is two or more times the average dose. Conversely, in the case of d/W_{H} being 0.83, the absorbed dose at the target center is ¼ or less of the average dose.

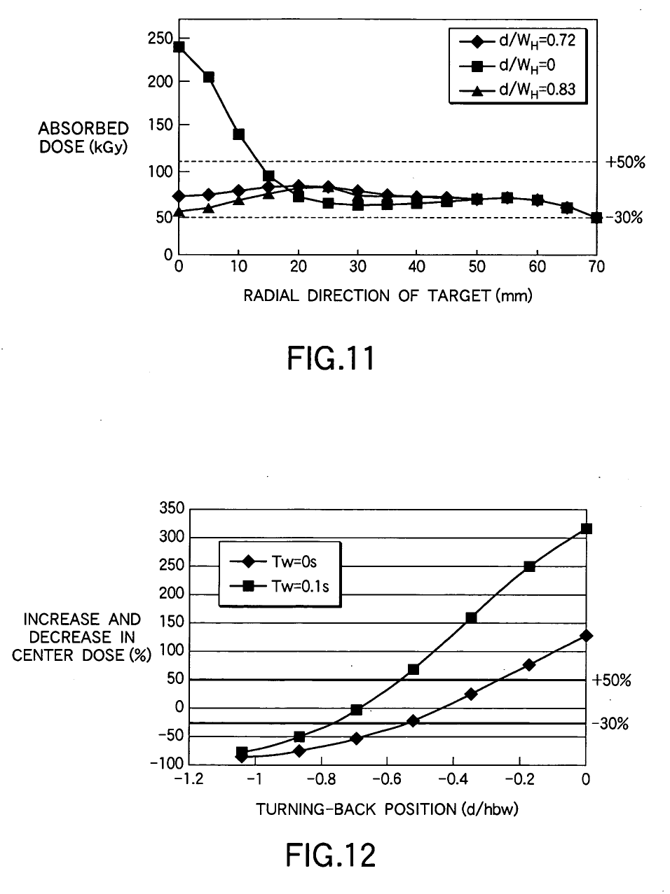

FIG. 11 shows distribution of absorbed doses in the case where acceleration performance at a turning-back position is taken into consideration. More specifically, it shows the case where a relative speed is 0 at a turning-back position for a time equivalent to about 5% of the total irradiating time, that is, a target is at a standstill (center absorbed dose 70 kGy). In this case, d/W_{H} is caused to vary to 0, 0.72, and 0.83. Unlike the case of FIG. 10, the absorbed dose increases by the amount of stop time. Therefore, in the case of FIG. 11, when d/W_{H} is 0, that is, a target turns back at a position where its center coincides with an irradiating tube center, the absorbed dose at the target center is four or more times the average dose. In the case of FIG. 10 where there is no stop time at a turning-back position, uniformity is best when d is about ½ of W_{H}, but in the case where there is stop time at a turning-back position, uniformity is best when d/W_{H} is about 0.7. When d/W_{H}=0.83, the absorbed dose at the target center is higher than that of FIG. 10, but is insufficient because it is about −40% of the average dose. In this case, it is possible to increase the absorbed dose at the target center by making stop time longer, but conversely the absorbed dose at a turning-back position (distance of about 20 mm in FIG. 11) will increase.

FIG. 12 shows doses absorbed at a target center when the turning-back position is varied, in terms of an increase and decrease from an average value (70 kGy), for the case where stop time is 0 (T_{W}=0 s) and the case where stop time is about 5% of the total irradiating time (T_{W}=5 s). As shown in the figure, in order to cause the absorbed dose to be in the preferred range of −30% to +50%, when there is no stop time the value of d/W_{H} has to be in a range of 0.25 to 0.58, and when the stop time is 5% of the total irradiating time the value of d/W_{H} has to be in a range of 0.56 to 0.79. That is, from these cases an allowable range of d/W_{H} is 0.25 to 0.79, so if the value of d/W_{H} is determined according to the acceleration performance at a turning-back position, satisfactory dose uniformity can be obtained.

From the foregoing description it is preferable that the range of d/W_{H} be 0.25 to 0.79. The aforementioned simulation results were obtained when half-value width W_{H}=23 mm. When d/W_{H}=0.25, d=5.8, and when d/W_{H}=0.79, d=18.2. Therefore, the preferred range of d is 5.8 to 18. 2 mm. In addition, when there is no stop time at a turning-back position, it is preferable that d/W_{H} be about 0.5, that is, the turning-back position be a position about W_{H}/2 away from the target center.

Preferably, the time during a linear movement (time from when a target starts moving to when it has returned), that is, the product of the irradiating time (s) and number of revolutions (rpm) is 300 (s·rpm) or more. If this value is less than 300 (s·rpm), a variation in irradiation dose becomes great. Conversely, if this value is too large, high-speed revolution is required and not practical. Considering this point, a preferable range is 1600 (s·rpm) or less. A further preferable range is 400 to 1600 (s·rpm).

It is preferable that the speed of the relative linear movement between the electron beam irradiating tube 22 and the target 1 be controlled, considering uniformity in irradiation doses. Preferably, the speed of the linear movement is made faster as it goes closer to the center of the target 1. For example, when the time during the linear movement (time from when the target 1 starts moving to when it has returned) is 2 seconds, it is preferable that the speed be 0 to 20 mm/s near an end portion of the target 1 and 60 to 180 mm/s near the target center.

In addition, while the target 1 is being rotated, between the electron beam irradiating tube 22 and the target 1 there is generated a relative linear movement such that the electron beam irradiating tube 22 turns back before the center 22b of the electron beam emitting portion 22a of the electron beam irradiating tube 22 reaches the center 1b of the target 1. Therefore, the flow of inert gas introduced through the inert gas introduction tube 32 can be made uniform at the surface of the target 1, and a stable coating with high flatness can be obtained.

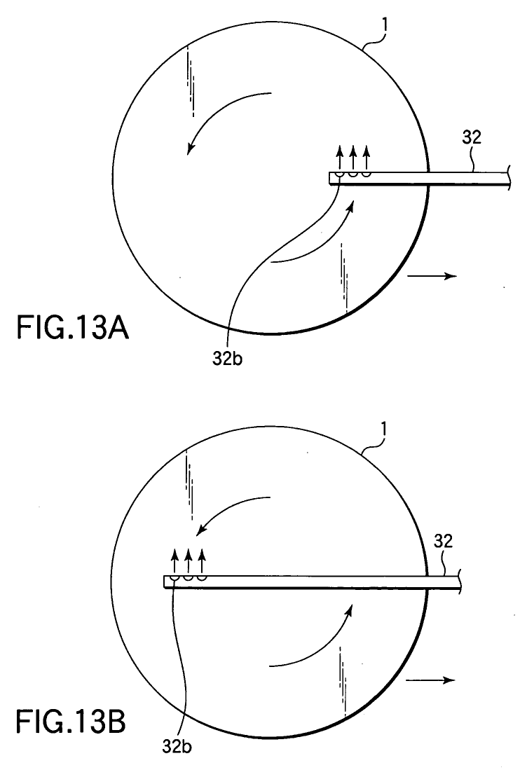

An inert gas is discharged perpendicularly in the direction where the inert-gas introduction tube 32 extends, through discharge holes 32b formed in the peripheral wall of the front end portion of the inert-gas introduction tube 32. Therefore, in the case where, while the target 1 is being rotated, there is generated a relative linear movement such that the electron beam irradiating tube 22 goes beyond the center of the target 1, as shown in FIGS. 13A and 13B, the discharge holes 32 go beyond the center of the target 1 and, behind or in front of the target center, the gas discharging direction becomes opposite to the direction of rotation of the target 1. Because of this, there are cases where an uncured coating will undulate due to wind pressure, and consequently, the flatness of the cured coating is reduced. To the contrary, in the first embodiment, there is generated a relative linear movement such that the electron beam irradiating tube 22 turns back before the center 22b of the electron beam emitting portion 22a of the electron beam irradiating tube 22 reaches the center 1b of the target 1. Therefore, since there is no possibility that the gas discharging direction will become opposite to the direction of rotation of the target 1, a stable coating with high flatness can be obtained.

In the first embodiment, an electron beam is irradiated from one electron beam irradiating tube 22 to the target 1, while rotating the target 1 on its own axis and generating a relative linear movement between the target 1 and the electron beam irradiating tube 22. Therefore, in addition to being able to enhance the uniformity of irradiation doses, the size of the apparatus can be reduced and the amount of inert gas employed to prevent oxygen inhibition relative to the target 1 is reduced and therefore the running cost is low. By generating a relative linear movement between the target 1 and the electron beam irradiating tube 22 while rotating the target 1 on its own axis, the whole surface of the target can be irradiated in a short time with one electron beam irradiating tube 22, and since the apparatus itself is small in size, an inert gas is introduced into the apparatus in a short time and therefore the cycle of processing the target 1 by electron-beam irradiation can be shortened.

In addition, the apparatus is constructed so that it has the chamber 10 which is capable of X-ray shielding and airtight holding and which functions as a transfer container; the transfer mechanism 50 for turning and transferring the target 1 within the chamber 10; the electron beam irradiation section 30 for irradiating an electron beam to the target 1; and the replacing chamber 40 for replacing the target 1. Therefore, this construction suffices if the entire transfer system has a space for turning the target 1. This can further reduce the size of the entire apparatus.

The support tray 51 for supporting the target 1, and the target holding tray 62 of the replacement mechanism 60, constitute the replacing chamber 40 which functions as a load-lock chamber. This makes it possible to replace the target 1, without reducing the inert gas of the chamber 10 and without causing leakage of X-rays generated by the electron beam emitting portion 20. Furthermore, it is not necessary to provide a special load-lock chamber and to provide a large-scale shielding chamber made of lead separately. This also makes it possible to reduce the size of the apparatus.

The flow rate of an inert gas for cooling down the vacuum type irradiating tube 22 of the electron beam irradiation section 20 is controlled by feedback control that is based on the temperature of the electron beam emitting portion 22a (irradiation window 105) of the vacuum type irradiating tube 22 detected by the temperature sensor 34. This can further reduce the amount of an inert gas used.

In the first embodiment, while the absorbed dose is 70 kGy, the dose maybe a range of 20 to 150 kGy. The preferred range is 40 to 100 kGy.

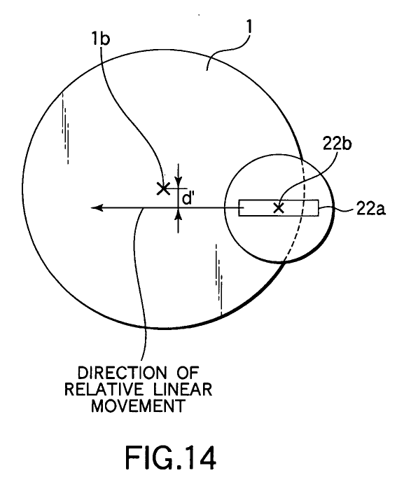

Next, a second embodiment will now-be explained. Referring to FIG. 14, there is shown how a relative linear movement between a target and an electron beam irradiating tube is generated in accordance with the second embodiment of the present invention. In the second embodiment, as shown in the figure, the center 22b of the electron beam emitting portion 22a of the electron beam irradiating tube 22 is moved along a straight line shifted by a distance d′ from the center 1b of a target 1. Unlike the first embodiment, in a relative linear movement generated by movement of the target 1, even if the center position of the electron beam irradiating tube 22 reaches the position corresponding center of the target 1, the electron beam irradiating tube 22 may go beyond the target center position. That is, because the center of the electron beam irradiating tube 22 passes the position shifted from the center of the target 1, the absorbed dose in the central portion of the target can be reduced even in the case where the center position of the electron beam irradiating tube 22 arrives at the position corresponding center of the target 1, whereby uniformity in irradiation doses can be enhanced. In the first embodiment, as set forth above, the electron beam irradiating tube 22 turns back before the center of the electron beam irradiating tube 22 reaches the center of the target 1, so the center of the electron beam irradiating tube 22 does not have to be shifted from the center of the target 1.

The aforementioned embodiments are arbitrary and are intended to clarify the technical content of the present invention. Thus, the invention should not be limited to the details given herein, but may be modified and implemented within the spirit and scope of the invention hereinafter claimed.

For instance, while the electron beam irradiating tube employed in the aforementioned embodiments is of a vacuum type, the present invention may use conventional drum-type electron beam irradiating tubes.

While the target employed in the aforementioned embodiments has a disk shape, the present invention is not to be limited to the disk target. In addition, the present invention is not to be limited to the case where an electron beam is irradiated to cross-link or cure a resin, but may be applied to other uses such as sterilization.

In the aforementioned embodiments, a relative linear movement between the target and the electron beam irradiating tube is generated by moving the target, but the electron beam irradiating tube or both may be moved. In the aforementioned embodiments, two support trays are provided for supporting targets, but the number of support trays may be 3 or more. Although the aforementioned embodiments employ one electron beam irradiating tube, the present invention is not to be limited to this. However, one electron beam irradiating tube is enough to carry out the present invention and is also preferable from an aspect of downsizing.

Finally, the present invention may further include various changes and modifications made without departing from the scope of the invention, by suitably combining or removing some of the components of the aforementioned embodiments.

What is claimed is:

1. An electron beam irradiation apparatus comprising:
an electron beam emission section having an electron beam irradiating tube that emits an electron beam;
an electron beam irradiation section for irradiating to a target the electron beam emitted from the electron beam emission section;
a transfer mechanism for transferring the target to the electron beam irradiation section;
a rotation mechanism for rotating the target on its own axis when irradiating the electron beam to the target; and
a linear movement mechanism for generating a relative linear movement such that the electron beam irradiating tube passes above the target, between the target and the electron beam irradiating tube, when irradiating the electron beam to the target;
wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section by the transfer mechanism.

2. The apparatus according to claim 1, wherein the linear movement mechanism generates the relative linear movement so that the center of the electron beam emitting portion of the electron beam irradiating tube does not pass the center of the target.

3. The apparatus according to claim 1, wherein the electron beam emission section has a single electron beam irradiating tube.

4. The apparatus according to claim 1, wherein the electron beam irradiating tube is of a vacuum tube type.

5. The apparatus according to claim 4, wherein an accelerating voltage for the electron beam that is taken out from the electron beam irradiating tube is 80 kV or less.

6. An electron beam irradiation apparatus comprising:
an electron beam emission section having an electron beam irradiating tube that emits an electron beam;
an electron beam irradiation section for irradiating to a target the electron beam emitted from the electron beam emission section;
a transfer mechanism for transferring the target to the electron beam irradiation section;
a rotation mechanism for rotating the target on its own axis when irradiating the electron beam to the target; and
a linear movement mechanism for generating a relative linear movement such that the electron beam irradiating tube passes right above the target, between the target and the electron beam irradiating tube, when irradiating the electron beam to the target;
wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section by the transfer mechanism;
and wherein, during the irradiation, the linear movement mechanism generates a relative linear movement such that the electron beam irradiating tube goes from an end portion of the target toward the center of the target and turns back before the center of an electron beam emitting portion of the electron beam irradiating tube reaches the center of the target.

7. The apparatus according to claim 6, wherein, when irradiation doses from the electron beam irradiating tube are normally distributed so that the center thereof is strongest, d/W_{H} (where W_{H} is the half-value width and d is the distance of the turning-back position from the center of the target) is a position that is in a range of 0.25 to 0.79.

8. The apparatus according to claim 7, wherein the turning-back position during the relative linear movement of the linear movement mechanism is a position 5.8 to 18.2 mm away from the center of the target.

9. The apparatus according to claim 8, wherein, when the relative linear movement has no stop time at the turning-back position, the turning-back position during the relative linear movement is a position W_{H}/2 away from the center of the target.

10. The apparatus according to claim 6, wherein the electron beam emission section has a single electron beam irradiating tube.

11. The apparatus according to claim 6, wherein the electron beam irradiating tube is of a vacuum tube type.

12. The apparatus according to claim 11, wherein an accelerating voltage for the electron beam that is taken out from the electron beam irradiating tube is 80 kV or less.

13. An electron beam irradiation apparatus comprising:
a transfer container which is capable of X-ray shielding and airtight holding and in which a target is turned and transferred;
a transfer mechanism for turning and transferring the target within the transfer container;
an electron beam irradiation section, formed within the transfer container, for irradiating an electron beam to the target;
a replacing chamber formed within the transfer container so that the target can be replaced;
an electron beam emission section, having an electron beam irradiating tube that emits an electron beam, for emitting the electron beam to the target in the electron beam irradiation section;
a replacement mechanism for replacing the target in the replacing chamber;
a rotation mechanism for rotating the target on its own axis when irradiating the electron beam to the target; and
a linear movement mechanism for generating a relative linear movement such that the electron beam irradiating tube passes right above the target, between the target and the electron beam irradiating tube, when irradiating the electron beam to the target;
wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section of the transfer container by the transfer mechanism.

14. The apparatus according to claim 13, wherein the linear movement mechanism generates the relative linear movement so that the center of an electron beam emitting portion of the electron beam irradiating tube does not pass the center of the target.

15. The apparatus according to claim 13, wherein the transfer mechanism includes a support tray that has a target support member for supporting the target, and turns the target within the support tray with the target supported by the target support member.

16. The apparatus according to claim 13, wherein
the replacement mechanism has a target holding tray for holding the target and an external transfer mechanism for transferring the target holding tray between a first position in the transfer container at which the replacing chamber is formed and a second position outside the transfer container; and
the target holding tray becomes part of the replacing chamber while holding a target held at the second position outside the transfer container, and causes the replacing chamber to be in an X-ray shielding and airtight state in cooperation with the support tray positioned in the replacing chamber, and in the X-ray shielding and airtight state, the target being held by the target holding tray is transferred to the support tray positioned in the replacing chamber.

17. The apparatus according to claim 16, further comprising:
a depressurization mechanism for depressurizing the replacing chamber airtightly held; and
a gas mechanism for filling the replacing chamber with an inert gas by introducing the inert gas into the replacing chamber after or during decompression;
wherein, in replacing the target, the replacing chamber is opened to the atmosphere, and after the target is transferred into the replacing chamber, the replacing chamber is caused to be in an inert-gas atmosphere.

18. The apparatus according to claim 13, wherein the transfer mechanism includes a plurality of support trays each having a target support member that supports a target;
when one of the support trays is positioned in the electron beam irradiation section, at least one support tray of the other support trays is positioned in the replacing chamber; and
in the state, while an electron beam is being irradiated to one target in the electron beam irradiation section, another target is replaced in the replacing chamber.

19. The apparatus according to claim 15, further comprising:
a vertical-movement mechanism for vertically moving the transfer mechanism;
wherein, when a target is supported within the support tray by the target support member and the support tray is positioned in the replacing chamber, the transfer mechanism is raised by the vertical-movement mechanism so that the replacing chamber is caused to be in an X-ray shielding and airtight state.

20. The apparatus according to claim 15, wherein the linear movement mechanism realizes a relative linear movement between the electron beam irradiating tube and the target by linearly moving the target support member.

21. The apparatus according to claim 15, wherein the rotation mechanism has a power transmission member for transmitting a rotating force to the target support member, a rotating shaft attached to the power transmission member, and a rotating unit for rotating the rotating shaft;
the linear movement mechanism has a linear drive unit for transmitting a linearly driving force to the target support member by horizontally moving the power transmission member and the rotating shaft; and
the power transmission member is provided so that it is able to contact to or separate from the target support member.

22. The apparatus according to claim 13, wherein the electron beam emission section has a single electron beam irradiating tube.

23. The apparatus according to claim 13, wherein the electron beam irradiating tube is of a vacuum tube type.

24. The apparatus according to claim 23, wherein an accelerating voltage for the electron beam that is taken out from the electron beam irradiating tube is 80 kV or less.

25. An electron beam irradiation apparatus comprising:
a transfer container which is capable of X-ray shielding and airtight holding and in which a target is turned and transferred;
a transfer mechanism for turning and transferring the target within the transfer container;
an electron beam irradiation section, formed within the transfer container, for irradiating an electron beam to the target;
a replacing chamber formed within the transfer container so that the target can be replaced;
an electron beam emission section, having an electron beam irradiating tube that emits an electron beam, for emitting the electron beam to the target in the electron beam irradiation section;
a replacement mechanism for replacing the target in the replacing chamber;
a rotation mechanism for rotating the target on its own axis when irradiating the electron beam to the target; and
a linear movement mechanism for generating a relative linear movement such that the electron beam irradiating tube passes right above the target, between the target and the electron beam irradiating tube, when irradiating the electron beam to the target;
wherein the electron beam is irradiated from the electron beam irradiating tube to the target, while rotating the target on its own axis by the rotation mechanism and also generating a relative linear movement between the target and the electron beam irradiating tube by the linear movement mechanism, when the target is transferred to the electron beam irradiation section of the transfer container by the transfer mechanism;
and wherein, during the irradiation, the linear movement mechanism generates a relative linear movement such that the electron beam irradiating tube goes from an end portion of the target toward the center of the target and turns back before the center of an electron beam emitting portion of the electron beam irradiating tube reaches the center of the target.

26. The apparatus according to claim 25, wherein, when irradiation doses from the electron beam irradiating tube are normally distributed so that the center thereof is strongest, d/W_{H} (where W_{H} is the half-value width and d is the distance of the turning-back position from the center of the target) is a position that is in a range of 0.25 to 0.79.

27. The apparatus according to claim 26, wherein the turning-back position during the relative linear movement of the linear movement mechanism is a position 5.8 to 18.2 mm away from the center of the target.

28. The apparatus according to claim 27, wherein, when the relative linear movement has no stop time at the turning-back position, the turning-back position during the relative linear movement is a position W_{H}/2 away from the center of the target.

29. The apparatus according to claim 25, wherein the transfer mechanism includes a support tray that has a target support member for supporting the target, and turns the target within the support tray with the target supported by the target support member.

30. The apparatus according to claim 25, wherein
the replacement mechanism has a target holding tray for holding the target and an external transfer mechanism for transferring the target holding tray between a first position in the transfer container at which the replacing chamber is formed and a second position outside the transfer container; and
the target holding tray becomes part of the replacing chamber while holding a target held at the second position outside the transfer container, and causes the replacing chamber to be in an X-ray shielding and airtight state in cooperation with the support tray positioned in the replacing chamber, and in the X-ray shielding and airtight state, the target being held by the target holding tray is transferred to the support tray positioned in the replacing chamber.

31. The apparatus according to claim 30, further comprising:
a depressurization mechanism for depressurizing the replacing chamber airtightly held; and
a gas mechanism for filling the replacing chamber with an inert gas by introducing the inert gas into the replacing chamber after or during decompression;
wherein, in replacing the target, the replacing chamber is opened to the atmosphere, and after the target is transferred into the replacing chamber, the replacing chamber is caused to be in an inert-gas atmosphere.

32. The apparatus according to claim 25, wherein
the transfer mechanism includes a plurality of support trays each having a target support member that supports a target;
when one of the support trays is positioned in the electron beam irradiation section, at least one support tray of the other support trays is positioned in the replacing chamber; and
in the state, while an electron beam is being irradiated to one target in the electron beam irradiation section, another target is replaced in the replacing chamber.

33. The apparatus according to claim 29, further comprising:
a vertical-movement mechanism for vertically moving the transfer mechanism;
wherein, when a target is supported within the support tray by the target support member and the support tray is positioned in the replacing chamber, the transfer mechanism is raised by the vertical-movement mechanism so that the replacing chamber is caused to be in an X-ray shielding and airtight state.

34. The apparatus according to claim 29, wherein the linear movement mechanism realizes a relative linear movement between the electron beam irradiating tube and the target by linearly moving the target support member.

35. The apparatus according to claim 29, wherein
the rotation mechanism has a power transmission member for transmitting a rotating force to the target support member, a rotating shaft attached to the power transmission member, and a rotating unit for rotating the rotating shaft;
the linear movement mechanism has a linear drive unit for transmitting a linearly driving force to the target support member by horizontally moving the power transmission member and the rotating shaft; and
the power transmission member is provided so that it is able to contact to or separate from the target support member.

36. The apparatus according to claim 25, wherein the electron beam emission section has a single electron beam irradiating tube.

37. The apparatus according to claim 25, wherein the electron beam irradiating tube is of a vacuum tube type.

38. The apparatus according to claim 37, wherein an accelerating voltage for the electron beam that is taken out from the electron beam irradiating tube is 80 kV or less.

39. An electron beam irradiation method of irradiating to a target an electron beam emitted from an electron beam irradiating tube, the method comprising the step of:
irradiating the electron beam from the electron beam irradiating tube to the target, while rotating the target on its own axis and also generating a relative linear movement such that the electron beam irradiating tube passes right above the target, between the target and the electron beam irradiating tube.

40. The method according to claim 39, wherein the relative linear movement is generated so that the center of an electron beam emitting portion of the electron beam irradiating tube does not pass the center of the target.

41. The method according to claim 39, wherein the electron beam is irradiated from a single electron beam irradiating tube.

42. The method according to claim 39, wherein a relative linear movement is realized between the electron beam irradiating tube and the target by linearly moving the target.

43. The method according to claim 39, wherein the electron beam irradiating tube is of a vacuum tube type.

44. The method according to claim 43, wherein an accelerating voltage for the electron beam that is taken out from the electron beam irradiating tube is 80 kV or less.

45. An electron beam irradiation method of irradiating to a target an electron beam emitted from an electron beam irradiating tube, the method comprising the steps of:
irradiating the electron beam from the electron beam irradiating tube to the target, while rotating the target on its own axis and also generating a relative linear movement such that the electron beam irradiating tube passes right above the target, between the target and the electron beam irradiating tube; and
during the irradiation, generating a relative linear movement such that the electron beam irradiating tube goes from an end portion of the target toward the center of the target and turns back before the center of an electron beam emitting portion of the electron beam irradiating tube reaches the center of the target.

46. The method according to claim 45, wherein, when irradiation doses from the electron beam irradiating tube are normally distributed so that the center thereof is strongest, d/W_{H} (where W_{H} is the half-value width and d is the distance of the turning-back position from the center of the target) is a position that is in a range of 0.25 to 0.79.

47. The method according to claim 46, wherein the turning-back position during the relative linear movement is a position 5.8 to 18.2 mm away from the center of the target.

48. The method according to claim 47, wherein, when the relative linear movement has no stop time at the turning-back position, the turning-back position during the relative linear movement is a position W_{H}/2 away from the center of the target.

49. The method according to claim 45, wherein the electron beam is irradiated from a single electron beam irradiating tube.

50. The method according to claim 45, wherein a relative linear movement is realized between the electron beam irradiating tube and the target by linearly moving the target.

51. The method according to claim 45, wherein the electron beam irradiating tube is of a vacuum tube type.

52. The method according to claim 51, wherein an accelerating voltage for the electron beam that is taken out from the electron beam irradiating tube is 80 kV or less.
